(19) United States
(12) Patent Application Publication
(10) Pub. No.: US 2024/0228887 A1
(43) Pub. Date: Jul. 11, 2024

(54) METHOD AND DEVICE FOR PRODUCING HYDROCARBONS FROM POLYMER WASTE

(71) Applicant: VIPS ENGINEERING LIMITED LIABILITY COMPANY, Saint-Petersburg (RU)

(72) Inventors: Andrey Anatolievich PANFEROV, Saint-Petersburg (RU); Mark Igorevich ORONOV, Saint-Petersburg (RU); Dmitry Evgenievich SMIRNOV, Saint-Petersburg (RU)

(73) Assignee: VIPS ENGINEERING LIMITED LIABILITY COMPANY, Saint-Petersburg (RU)

(21) Appl. No.: 18/614,991

(22) Filed: Mar. 25, 2024

Related U.S. Application Data
(63) Continuation of application No. PCT/RU2022/050298, filed on Sep. 19, 2022.

(30) Foreign Application Priority Data
Sep. 23, 2021 (RU) 2021127920

(51) Int. Cl. C10G 1/10; B01J 8/00; B01J 8/24

(52) U.S. Cl. CPC C10G 1/10; B01J 8/001; B01J 8/24; B01J 2208/00176; C10G 2300/1003; C10G 2300/202

(57) ABSTRACT

A method for producing hydrocarbons from polymer waste includes: A) heating pre-crushed polymer waste in the presence of a mixture of liquid hydrocarbons to a temperature sufficient to convert at least one target polymer from the polymer waste to solution, but a lower transition temperature to solution for the remaining components of the polymer waste, to produce a polymer-containing mixture including a solution of at least one target polymer in the liquid hydrocarbon mixture, and B) catalytic cracking of the polymer-containing mixture in the presence of an ultrafine catalyst at a temperature from at least 360° ° C. to produce a mixture of liquid and gaseous hydrocarbons.

### CROSS-REFERENCE TO RELATED APPLICATIONS

This application is a continuation of International Application No. PCT/RU2022/050298, filed on Sep. 19, 2022, which claims priority to Russian Patent Application No. 2021127920, filed on Sep. 23, 2021. The disclosures of the above-mentioned applications are hereby incorporated by reference in their entireties.

### TECHNICAL FIELD

The application relates to a method for obtaining hydrocarbons from polymer waste by catalytic cracking of a polymer-containing mixture with the preliminary production of a polymer-containing mixture from polymer waste containing a solution of the target polymer in a liquid hydrocarbon mixture.

### BACKGROUND

Due to the large amount of polymer waste, the issue of recycling polymer waste to avoid environmental pollution is currently acute. It is also desirable to obtain products from polymer waste that can be further used in various fields of technology.

U.S. Pat. No. 4,175,211A describes a method for processing polymer waste, including melting polymer waste in the presence of heavy recycled gas oil followed by catalytic cracking using a dispersed catalyst. One of the disadvantages of this method is the lack of effective separation of target polymers from non-target products. Another disadvantage of the prior technology method is the need for catalytic cracking at high temperatures, which leads to significantly increased energy requirements for the process and to a reduced yield of the final commercial product. The next disadvantage of this method is the direct loading of the dispersed catalyst in the form of particles into the catalytic cracking reactor, in which the catalyst losses associated with its carryover by technological flows are inevitable, which requires a higher catalyst consumption and, in general, negatively affects the overall efficiency of the process.

### SUMMARY

The application is based on the task of creating a method for obtaining hydrocarbons from polymer waste, which, due to the effective separation of target polymers from non-target products and due to the use of a catalyst that provides the ability to carry out catalytic cracking at low temperatures, makes it possible to significantly reduce the requirements for the energy of the process and increase the yield of the final commercial product.

One of the technical results of the present application is to provide a method for obtaining hydrocarbons from polymer waste with high efficiency, by converting polymers contained in polymer waste.

Another technical result of the present application is to ensure the efficient use of a catalyst in catalytic cracking of a polymer-containing mixture.

Another technical result of the present application is the efficient purification/selection of target polymers from polymer wastes.

This problem is solved, and the technical results are achieved by means of a method for obtaining hydrocarbons from polymer wastes according to the present application.

The present application relates to a method for producing hydrocarbons from polymer wastes, including:
A) heating the pre-shredded polymer waste in the presence of a liquid hydrocarbon mixture to a temperature sufficient for the transition of at least one target polymer from the polymer waste to solution, but less than the conversion temperature of the remaining components of the polymer waste to solution, to obtain a polymer-containing mixture containing a solution of at least one target polymer in the liquid hydrocarbon mixture;
B) catalytic cracking of a polymer-containing mixture in the presence of an ultrafine catalyst at a temperature of at least 360° C. to obtain a mixture of liquid and gaseous hydrocarbons.

In one embodiment, a method is provided wherein the target polymer is polyolefin.

In one embodiment, a method is provided in which the transition temperature of polymer waste fractions containing polyethylene, polypropylene to the liquid phase is maintained in the range of 200 to 250° C.

In one embodiment, a method is provided where the undissolved impurities include fluorine and nitrogen-containing compounds.

In one embodiment, a method is provided that further includes filtration and/or separation of the polymer-containing mixture prior to its delivery to the catalytic cracking step with the separation of the remaining polymer waste fractions containing mechanical and undissolved impurities in the liquid hydrocarbon mixture.

In one embodiment, a method is provided in which the catalyst is produced by dispersing in a homogenizer the catalyst precursor in a liquid hydrocarbon mixture, the precursor being an organometallic compound. In one embodiment, the liquid hydrocarbon mixture may be a liquid hydrocarbon mixture from step B).

In one embodiment, a method is provided in which an organometallic compound is selected from a group consisting of metal-containing salts of C16-C32 carboxylic acids and mixtures thereof, where the metal is selected from a group consisting of nickel, cobalt, and molybdenum.

In one embodiment, a method is provided in which the catalyst has a particle size of less than 8 angstroms.

In one embodiment, a method is provided where the polyolefin is polyethylene or polypropylene.

In one embodiment, a method is provided that further includes step C) returning at least a portion of the liquid hydrocarbon mixture produced in step B) to step A).

In one embodiment, a method is provided where step B) a recirculation circuit is provided for a polymer-containing mixture with a catalyst applied.

The present application also provides a method for isolating a target polymer from polymer waste, including:
A) provision of shredded polymer waste,
B) heating the shredded polymer waste in the presence of a liquid hydrocarbon mixture to a temperature sufficient for the transition of at least one target polymer from the polymer waste to solution, but less than the conversion temperature of the remaining components of the polymer waste into solution, resulting in a polymer-containing mixture containing a solution of at least one target polymer in the liquid hydrocarbon mixture.

In one embodiment, a method is provided where the liquid hydrocarbon mixture is a liquid hydrocarbon mixture obtained by catalytic cracking of a polymer-containing mixture.

In one embodiment, a method is provided that further includes filtration and/or separation of the polymer-containing mixture with separation from it of the remaining polymer waste fractions containing mechanical and undissolved impurities in the liquid hydrocarbon mixture.

In one embodiment, a method is provided where the liquid hydrocarbon mixture is heavy hydrocarbon fractions produced by catalytic cracking of the polymer-containing mixture.

In one embodiment, a method is provided where the target polymer is polyolefin.

Further, the present application provides a method for catalytic cracking of a polymer-containing mixture obtained from polymer waste, the method including:
A) provision of a polymer-containing mixture including at least one polymer,
B) catalytic cracking of a polymer-containing mixture in the presence of an ultrafine catalyst at a temperature of at least 360° ° C. to obtain a mixture of liquid and gaseous hydrocarbons.

Moreover, the catalyst is obtained by dispersing the catalyst precursor in a homogenizer in a liquid hydrocarbon mixture.

In one embodiment, a method is provided where the liquid hydrocarbon mixture is a liquid hydrocarbon mixture obtained by catalytic cracking of a polymer-containing mixture.

In one embodiment, a method is provided where the liquid hydrocarbon mixture is heavy hydrocarbon fractions produced by catalytic cracking of the polymer-containing mixture.

In one embodiment, a method is provided that further includes a recirculation circuit for a polymer-containing mixture with a catalyst applied.

In addition, the present application relates to a device to produce hydrocarbons from polymer waste, including:
a mixing reactor configured to heat the pre-shredded polymer waste in the presence of a liquid hydrocarbon mixture to a temperature sufficient for the transition of at least one target polymer from the polymer waste to solution, but a lower transition temperature to solution for the remaining components of the polymer waste, to obtain a polymer-containing mixture containing a solution of at least one target polymer in a liquid hydrocarbon mixture,
an evaporator reactor configured to receive a polymer-containing mixture from a mixing reactor and catalytic cracking of the polymer-containing mixture in the presence of an ultra-dispersed catalyst at a temperature of at least 360° C. to produce a mixture of liquid and gaseous hydrocarbons, and
a homogenizer made with the ability to disperse the catalyst precursor in a liquid hydrocarbon mixture for supply to the evaporator reactor.

In one embodiment, a device is provided that further includes a filter and/or a first separator configured to receive a polymer-containing mixture from a mixer reactor and separate impurities from it.

In one embodiment, a device is provided that additionally includes a heat exchanger designed to receive a polymer-containing mixture from a mixer reactor with additional heating. The heat exchanger is designed to receive the steam-gas mixture from the evaporator reactor and ensure its cooling.

In one embodiment, a device is provided that additionally includes a fire heating furnace configured to receive a polymer-containing mixture with an introduced catalyst, where the device provides a recirculation circuit for the polymer-containing mixture with the introduced catalyst from the evaporator reactor to the firing furnace and back to the evaporator reactor.

According to one embodiment, a device is provided, which additionally includes a second separator made with the possibility of receiving a vapor-gas mixture from an evaporator reactor with its separation into fractions to obtain a liquid hydrocarbon mixture, where the device provides a first circuit for feeding a liquid hydrocarbon mixture, separated from the steam-gas mixture in the separator, to the reactor-mixer and a second supply circuit for a liquid hydrocarbon mixture separated from the vapor-gas mixture in separator, into an evaporator reactor.

### BRIEF DESCRIPTION OF THE DRAWINGS

FIG. 1 illustrates a simplified block diagram of a method for producing hydrocarbons from polymer waste of the present application.

### DETAILED DESCRIPTION OF THE EMBODIMENTS

The raw materials for the method according to the present application are polymer wastes of various types and purposes, including, but not limited to, polymer containers for various purposes, packaging of various products, and other household and industrial polymer waste.

The raw material is subjected to initial purification from large undesirable components, impurities with subsequent grinding in shredders. Further, the crushed raw material is cleaned of fine metal impurities, e.g., by means of separator(s), e.g., magnetic separator(s), followed by treatment in a press and crusher, and drying, e.g., in drum-cascade drying, to remove moisture by means of hot air while ensuring a low moisture content, in particular up to 5% by weight, preferably less than 3% by weight.

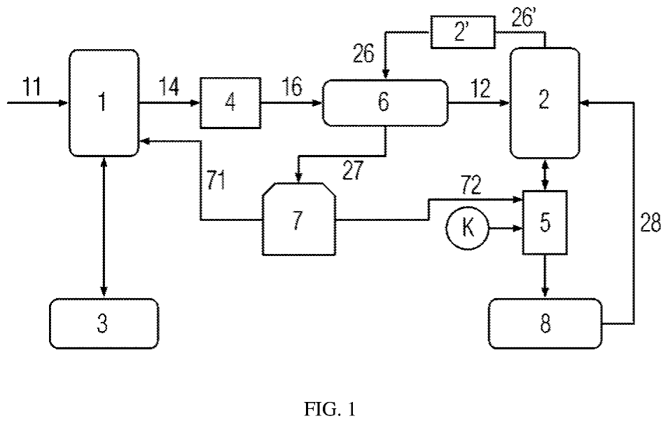

Referring to FIG. 1, the raw materials processed as described above are transported, for example, by a screw conveyor along line 11 to at least one reactor 1, in particular the mixing reactor 1. The steps of the method described above are well known and understood by one skilled in the technology and are therefore not described in detail herein.

In reactor 1, the polymer feedstock is melted in the presence of a liquid hydrocarbon mixture to produce a polymer-containing mixture including a solution of at least one target polymer in the liquid hydrocarbon mixture.

In particular, the pre-shredded polymer waste in the presence of a liquid hydrocarbon mixture is heated to a temperature sufficient to allow the transition of at least one target polymer from the polymer waste to solution, but a lower transition temperature to solution of the remaining components of the polymer waste, including polymers other than the target polymer(s), in order to obtain a polymer-containing mixture including a solution of at least one target polymer in the liquid mixture. In non-limiting embodiments, heating is carried out and the temperature in the reactor is between 200 and 250° C. It is understood that the temperature range of heating in the reactor can be varied depending on the target polymers and the nature and composition of the polymer waste.

The inventors of the present application have found that the application of melting polymer waste in a liquid hydrocarbon mixture to provide a polymer-containing mixture containing a solution of the target polymer in a liquid hydrocarbon mixture allows the selection of at least one target polymer by selectively dissolving it in a liquid hydrocarbon mixture, thereby ensuring the purification of the raw material from non-target components. The application of this temperature also additionally ensures the selection of at least one target polymer.

In general, according to the present application, a polymer-containing mixture is essentially a solution comprising at least one target polymer and a liquid hydrocarbon mixture. In particular, the polymer-containing mixture may be a melt whose viscosity is reduced by the inclusion of a liquid hydrocarbon mixture. Due to the indicated inclusion of the liquid hydrocarbon mixture, it is possible to transport the polymer-containing mixture by pumps and subsequent mechanical filtration to separate undesirable impurities, for example, particles of paper, cardboard, metal, as well as particles of other polymers insoluble under these conditions.

In general, according to the present application, the target polymer is polyolefin, in particular polyethylene, polypropylene, or a mixture thereof. However, the present application is not limited to these polymers, and other polyolefin polymers, e.g., polybutylene, may be used, depending on the nature and composition of the polymer waste. In general, according to the present application, the liquid hydrocarbon mixture is a heavy hydrocarbon fraction obtained by catalytic cracking of a polymer-containing mixture. At the start of the process of the present application, it is possible to use a single solvent as a liquid hydrocarbon mixture, e.g., diesel fuel, in particular low-sulphur diesel fuel.

The temperature in the reactor 1 is brought to the required value and maintained due to the circulation of the coolant heated in the furnace 3 of the fire heating.

After selection of the target polymers in the reactor 1 to provide improved purification of the polymer-containing mixture, the polymer-containing mixture is sent along line 14 for filtration to the filter 4 and/or separation to a separator (not shown) for the separation of undesirable impurities.

After filtration, the polymer-containing mixture produced in reactor 1 is transported, for example, by a pump (not shown) along lines 16 and 12 to the evaporator reactor 2 for catalytic cracking.

In evaporator reactor 2, the polymer-containing mixture undergoes catalytic cracking.

Together with the polymer-containing mixture, a catalyst is also fed into the evaporator reactor 2. According to the present application, the catalyst is a precursor to the K catalyst that is dispersed to an ultrafine state by homogenizer 5 in a liquid hydrocarbon mixture. Hereinafter, in the present application, the ultrafine state refers to particles that are less than 100 nanometres in size. This term is used in this field of technology, which follows, for example, from the open-source Wikipedia.

The mixture of the catalyst precursor K and the liquid hydrocarbon mixture may be a solution, lysol, or dispersion. The precursor K of the catalyst in the liquid hydrocarbon mixture is converted into catalyst particles when exposed to high temperature in the evaporator reactor 2, which in turn participate in the catalytic cracking process.

The inventors have found that the use of this method of obtaining a catalyst and feeding it into the reactor avoids catalyst losses associated with feeding the catalyst directly into the reactor. Also, it seems that the use of homogenizer 5 makes it possible to break down the micelles formed during normal dissolution, which, in turn, makes it possible to reduce the size of catalyst particles formed as a result of the thermal decomposition of the catalyst precursor K to a size of less than 8 angstroms, in particular, 1-8 angstroms, while the use of such small catalyst particle sizes allows to increase the number of active sites of the catalyst and increase the lifetime of the catalyst. This is because the agglomeration of such particles is much slower at the initial stage.

The use of an ultrafine catalyst makes it possible to place catalyst particles essentially in the entire working volume of the reactor. The inventors have found that this allows the catalytic cracking process to be carried out at low temperatures, at which, according to the prior art, catalytic cracking is impossible or extremely inefficient.

Catalytic cracking of the polymer-containing mixture according to the application is carried out at a temperature of 360-425° C., preferably at a temperature of 400-425° C. In a non-limiting embodiment, the products of the catalytic cracking reaction include paraffins, isoparaffins, aromatic compounds, naphthenes, olefins. In particular, the composition of the products of the catalytic cracking reaction includes 30 to 50 Mac. % of paraffins, 5 to 10 Mac. % of isoparaffins, 20 to 30 Mac. % of aromatic compounds, 5 to 10 Mac. % of naphthenes, 5 to 10 Mac. % of olefins. However, a person skilled in the technology will understand that the products of the catalytic cracking reaction depend on the nature and composition of the polymer waste, as well as the temperature regime of the process.

In general, according to the present application, the liquid hydrocarbon mixture used in the preparation of the catalyst is heavy hydrocarbon fractions obtained by catalytic cracking of the polymer-containing mixture. However, other applicable liquid hydrocarbons can also be used, e.g. diesel fuel, in particular low-sulphur diesel.

Heating of the evaporator reactor 2 can be carried out by means of a fire heating furnace 8. The polymer-containing mixture produced in the reactor 1 may be fed into the evaporator reactor 2 through the firing furnace 8 to heat it. A person skilled in the technology will appreciate that the mixture can be heated by other methods known in the art, e.g., by means of a heat exchanger. After the firing furnace 8, the polymer-containing mixture is directed, for example, through a pipeline to the evaporator reactor 2, whereby the mixture of catalyst precursor K is added to the pipeline and sent to the evaporator reactor 2. It is also possible to feed this mixture of catalyst precursor K directly into the evaporator reactor 2. The polymer-containing mixture subjected to a catalytic cracking process in the evaporator reactor 2 and containing catalyst particles may be sent to the firing furnace 8 and then sent back to the evaporator reactor 2 via line 28 with a recirculation circuit which may be closed. In addition, the use of this melt superheating scheme using a recirculation circuit avoids significant overheating of the mixture in the firing furnace 8 and does not require other methods of maintaining the temperature of the cubic residue of the evaporator reactor 2. Also, the catalyst particle can only leave the evaporator reactor 2 with a cubic residue after it has reached a significant particle size. Thus, due to the provision of a recirculation loop in the reactor 2, the catalyst accumulates, where the same catalyst particle repeatedly passes through the firing furnace 8 and the evaporator reactor 2 during its lifetime. Due to this, it is possible to increase the efficiency of the catalyst and the efficiency of the process.

In general, the precursor K of the catalyst is an organometallic compound, in particular, a metal-containing salt of C16-C32 carboxylic acids or mixtures thereof, the metal being selected from the group consisting of nickel, cobalt, and molybdenum.

The liquid hydrocarbon mixture used in the dissolution of polymer waste and the production of a catalyst may be heavy hydrocarbon fractions obtained by catalytic cracking of a polymer-containing mixture having a boiling point above 200° C., in particular, above 225° C., and an initial boiling point from 300° C. In a non-limiting embodiment, the vapor-gas mixture obtained by cracking the polymer-containing mixture, at least one separator 7 shall be routed along line 27 for separation into gas phase, light liquid fractions and heavy liquid fractions. At the same time, a part of the heavy fractions can be returned to the technological process for the above purposes along lines (circuits) 71 and 72, the rest is mixed with light liquid fractions to obtain a hydrocarbon liquid, which is a product for further use. In a non-limiting embodiment, the vapour-gas mixture obtained by cracking the polymer-containing mixture can be directed along line 26′ to an additional 2′ isomerization reactor, in which catalytic processes are carried out to isomerize the hydrocarbon structure towards isocomponents and/or dewax (destruct) normal paraffins. The 2′ isomerization reactor can be a catalytic reactor with a heterogeneous porous catalyst of the ZSM type, the MFI type and the Similar.

The inventors of the present application have found that the use of an additional 2′ isomerization reactor further improves the performance of the resulting products and additionally contributes to the production of hydrocarbons from polymer waste with high efficiency. In a non-limiting embodiment, the vapor-gas mixture produced by cracking the polymer-containing mixture and being isomerized in the isomerization reactor 2′ may be sent via line 26 to the heat exchanger 6, to which the polymer-containing mixture from the reactor 1 is also directed, for heat exchange, in which, respectively, the polymer-containing mixture is subjected to additional heating and the vapor-gas mixture is cooled to improve separation into individual fractions, this allows you to further increase the efficiency of the process. The vapor-gas mixture produced by cracking the polymer-containing mixture may also be sent directly to the heat exchanger 6 in the absence of the isomerization reactor 2′ or in parallel with it.

The inventors of the present application have also found that the most optimal conditions for catalytic cracking of polyolefins are a temperature of 380 to 425° C., a pressure from minus 0.1 to 5 MPa excessive, preferably minus 0.1 to 0.5 MPa, and a catalyst concentration from 0.005 to 0.02% Mac. (for metal). These conditions make it possible to further increase the efficiency of the process.

In a non-limiting embodiment, because of catalytic cracking of a polymer-containing mixture, in particular containing polyolefin(s), a wide fraction of hydrocarbons from methane to hydrocarbons with a boiling point from more than 400° C. of various group compositions are obtained: olefins, paraffins, aromatic compounds, as well as hydrogen, CO, CO₂. In a non-limiting embodiment, the following ratio between the fractions is obtained: gas fraction 5-15% Mac., low-boiling fraction nk−225° C. 20-30% Mac. and high-boiling fraction 150-kk° C., 50-80% Mac.

The following are examples of a method for obtaining hydrocarbons from polymer wastes according to the application.

### EXAMPLES

Polymer-containing raw materials were loaded into the mixer reactor and was carried out its melting with the provision of a solution of polymer-containing raw materials in a liquid hydrocarbon mixture. The temperature in the digester reactor was maintained in the range of 200-250° ° C. The crushed polyolefin raw materials were continuously or in batches loaded into the mixing reactor until the polyolefins were completely dissolved in the liquid hydrocarbon mixture and then sent for filtration to separate impurities. The consumption of raw materials was 0.5 hour⁻¹. Polymer waste containing polyethylene (PE) was used as a raw material. Next, the resulting solution was sent to the evaporator reactor for catalytic cracking. The conditions and results of catalytic cracking are shown in Table 1.

TABLE 1

| | | | | | | Output, Mac. % | | |
|---|---|---|---|---|---|---|---|---|
| | | R, MPa | Concentration of | | Conversion | Gas | nk-225° | 150-kk |
| Example | T-ra, S | (izb) | metal, % Mac. | | PE, % | (C1-C5) | C.* | ° C.* |
| 1 | 370 | 0.1 | 0.015 | Ni | 87.1 | 3.5 | 19.1 | 77.4 |
| 2 | 435 | 0.8 | 0.0075 | Co | 93.3 | 16.3 | 30.1 | 53.6 |
| 3 | 410 | 1.3 | 0.01 | Mo | 90.5 | 12.7 | 33.4 | 53.9 |
| 4 | 390 | 0.9 | 0.001 | Ni | 88.3 | 7.7 | 22.4 | 69.9 |
| 5 | 400 | 0.7 | 3.5 | Mo | 89.2 | 10.4 | 28.5 | 61.1 |
| 6 | 385 | 0.5 | 0.33 Co + | | 96.2 | 5.1 | 20.3 | 74.6 |
| | | | 0.033 Ni + | | | | | |
| | | | 0.02 Mo | | | | | |
| 7 | 400 | −0.1 | 1.53 | Ni | 95.4 | 7.5 | 9.8 | 82.7 |

nk-225° C.—fraction with boiling end 225° C.
150 kk ° C.—fraction with the beginning of boiling 150° C.

The presented examples show that by using the method of the present application, it is possible to provide an efficient method for obtaining hydrocarbons from polymer waste (high PE conversion) with optimal use of a catalyst.

What is claimed is:

1. A method for obtaining hydrocarbons from polymer waste, comprising:
A) heating pre-shredded polymer waste in the presence of a liquid hydrocarbon mixture to a temperature sufficient for a transition of at least one target polymer from the polymer waste to solution, but less than a conversion temperature of remaining components of the polymer waste to solution, to obtain a polymer-containing mixture containing a solution of at least one target polymer in the liquid hydrocarbon mixture;
B) catalytic cracking of the polymer-containing mixture in the presence of an ultrafine catalyst at a temperature of at least 360° C., producing a mixture of liquid and gaseous carbohydrates, a catalyst particle size of 8 angstroms or less being provided by dispersion in a homogenizer of a catalyst precursor in the liquid hydrocarbon mixture, the catalyst precursor being an organometallic compound; and
C) circulating the polymer-containing mixture closed with an introduced catalyst, which ensures a repeated passage of mixture through a firing furnace.

2. The method according to claim 1, wherein the target polymer is polyolefin, comprising polyethylene and/or polypropylene.

3. The method according to claim 2, wherein the conversion temperature of polymer waste fractions comprising polyethylene and/or polypropylene to the liquid phase is maintained in the range from 200 to 250° C.

4. The method according to claim 1, further comprising filtration and/or separation of the polymer-containing mixture prior to delivery the polymer-containing mixture to a catalytic cracking stage with a separation of remaining polymer waste fractions comprising mechanical and undissolved impurities in the liquid hydrocarbon mixture.

5. The method according to claim 4, wherein the undissolved impurities comprise fluorine and nitrogen-containing compounds.

6. The method according to claim 5, wherein the organometallic compound is selected from a group consisting of metal-containing salts C16-C32 of carboxylic acids and mixtures thereof, a metal is selected from a group consisting of nickel, cobalt, and molybdenum.

7. The method according to claim 1, wherein the catalytic cracking in step B) is carried out at a temperature of 380 to 425° C., a pressure from −0.1 to −0.5 MPa and catalyst concentrations from 0.005% to 0.02% Mac.

8. The method according to claim 1, further comprising step C) returning at least a portion of the liquid hydrocarbon mixture produced in step B) to step A).

9. The method according to claim 1, wherein the liquid hydrocarbon mixture is a mixture of the liquid hydrocarbons from step B).

10. A method of catalytic cracking of a polymer-containing mixture obtained from polymer waste, comprising:
A) providing the polymer-containing mixture comprising a solution of at least one polymer in a liquid hydrocarbon mixture;
B) catalytic cracking of the polymer-containing mixture in the presence of an ultrafine catalyst at a temperature of at least 360° C. to produce a mixture of liquid and gaseous hydrocarbons, catalyst particle size of 8 angstroms or less being provided by dispersion in a homogenizer of a catalyst precursor in the liquid hydrocarbon mixture, the catalyst precursor being an organometallic compound; and
C) circulating the polymer-containing mixture closed with an introduced catalyst so as to ensure a repeated passage of mixture through a firing furnace.

11. The method according to claim 10, wherein the liquid hydrocarbon mixture is the liquid hydrocarbon mixture obtained by catalytic cracking of the polymer-containing mixture.

12. The method according to claim 10, wherein the liquid hydrocarbon mixture is heavy hydrocarbon fractions obtained by catalytic cracking of the polymer-containing mixture.

13. The method according to claim 10, wherein catalytic cracking in step B) is carried out at a temperature from 380 to 425° C., a pressure from −0.1 to −0.5 MPa and catalyst concentrations from 0.005% to 0.02% Mac.

14. A device to produce hydrocarbons from polymer waste, comprising:
a mixing reactor configured to heat a pre-shredded polymer waste in the presence of a liquid hydrocarbon mixture to a temperature sufficient for a transition of at least one target polymer from the polymer waste to solution, but a lower transition temperature to solution for remaining components of the polymer waste, to obtain a polymer-containing mixture containing a solution of at least one target polymer in the liquid hydrocarbon mixture;
an evaporator reactor configured to receive the polymer-containing mixture from the mixing reactor and catalytic cracking of the polymer-containing mixture in the presence of an ultrafine catalyst with a particle size of 8 angstroms or less at a temperature from at least 360° C. to produce a mixture of liquid and gaseous hydrocarbons;
a homogenizer made with the ability to disperse a catalyst precursor in the liquid hydrocarbon mixture to be fed into the evaporator reactor; and
a firing heating furnace designed to receive the polymer-containing mixture with the catalyst introduced, and the device providing a recirculation circuit for the polymer-containing mixture with introduced catalyst from the evaporator reactor to a fire heating furnace and back to the evaporator reactor.

15. The device according to claim 14, further comprising a filter and/or a first separator, configured to receive the polymer-containing mixture from the mixing reactor and separate impurities from it.

16. The device according to claim 14, further comprising an isomerization reactor configured to receive a vapor-gas mixture from the mixing reactor.

17. The device according to claim 16, further comprising a heat exchanger configured to receive the vapor-gas mixture from the mixing reactor and/or the isomerization reactor and provide additional heating thereof.

18. The device according to claim 16, wherein the heat exchanger is configured to receive the vapor-gas mixture from the evaporator and/or the isomerization reactor and provide cooling thereof.

19. The device according to claim 14, further comprising a second separator configured to receive the vapor-gas mixture from the evaporator reactor and ensure its separation into fractions to obtain the liquid hydrocarbon mixture, wherein the device provides a primary circuit for feeding the liquid hydrocarbon mixture separated from the vapor-gas mixture in the separator to the mixing reactor and a second supply circuit for the mixture of liquid hydrocarbon separated from the vapor-gas mixture in the separator, into the evaporator reactor.
